(19) United States
(12) Patent Application Publication
(10) Pub. No.: US 2003/0016393 A1
(43) Pub. Date: Jan. 23, 2003

(54) Electronic service transaction and method

(76) Inventors: Steven C. Johnson, Eagle, ID (US); Shane R. Konsella, Boise, ID (US); Kwesi E. Abraham, Boise, ID (US); Arti Shukla, Eagle, ID (US); Jessop T. Dennis, Boise, ID (US); Michael L. Rishel, Star, ID (US)

Correspondence Address: HEWLETT-PACKARD COMPANY, Intellectual Property Administration, P.O. Box 272400, Fort Collins, CO, 80527-2400, US

(21) Appl. No.: 09/909,501

(22) Filed: Jul. 20, 2001

(51) Int. Cl. H04N 1/00

(52) U.S. Cl. 358/402

(57) ABSTRACT

An electronic service transaction apparatus includes a computer peripheral device. The computer peripheral device has a communication link with an electronic service site and a messaging system operative to provide store and forward capabilities with the electronic service site. The communication link connects the computer peripheral device with the Internet. The messaging system is accessed directly by the computer peripheral device to initiate an electronic service transaction from the computer peripheral device with the electronic service site. A method is also provided.

### FIELD OF THE INVENTION

This invention pertains to computer peripheral devices that initiate electronic service transactions within network environments. More particularly, this invention relates to the initiation and rendering of electronic service transactions over networks from computer peripheral devices, such as a printer initiating and rendering an electronic service transaction over the Internet or the World Wide Web (WWW).

### BACKGROUND OF THE INVENTION

As computer systems have gained widespread use, particularly within home environments, the use of computers and computer peripheral devices has increased significantly. More recently, computers have been connected to the Internet and the World Wide Web (WWW), a subset of the Internet. These connections have rendered users of such computers with the ability to access a wide array of electronic service transactions. Many of these transactions result in a user generating a print job that is delivered from the computer to an associated, networked, or dedicated printer, for purposes of generating a hard copy output.

A number of electronic services are available over the Internet. Customers can use a web browser to access web sites over the World Wide Web (WWW) of the Internet in order to find information and purchase goods. However, there exist a number of shortcomings to the present services.

A typical electronic service transaction needs to be initiated manually by a user, through a web browser on a personal computer. If the transaction is printer related, the user needs to be informed that a service exists and where to find the service on the Internet. If the transaction is printer related, the user also needs to know details about the particular printer model and configuration associated with the personal computer. If the transaction is printer related, the user further needs to track their own behavior and anticipate their own future needs. Even if the transaction is printer related, the user typically will still choose which services to use when conducting business. The user's choices may not necessarily coincide with the exact printer model being used by the user. Therefore, a printer manufacturer may not realize any financial advantage from this model.

Furthermore, any goods purchased by the user may not be compatible with the user's exact printer model and configuration.

Accordingly, a need exists for a solution that can initiate an electronic service transaction from a computer peripheral device without requiring the use of a personal computer or a host computer.

### SUMMARY OF THE INVENTION

An apparatus and method are provided to initiate an electronic service transaction from a computer peripheral device, such as from a printer.

According to one aspect, an electronic service transaction apparatus includes a computer peripheral device. The computer peripheral device has a communication link with an electronic service site and a messaging system operative to provide store and forward capabilities with the electronic service site. The communication link connects the computer peripheral device with the Internet. The messaging system is accessed directly by the computer peripheral device to initiate an electronic service transaction from the computer peripheral device with the electronic service site.

According to another aspect, a computer peripheral device includes an output engine, a transaction execution subsystem, a communication interface, and processing circuitry. The transaction execution subsystem communicates with the output engine. The communication interface communicates with the transaction execution subsystem. The processing circuitry communicates with the transaction execution subsystem and is operative to initiate an electronic services transaction from the transaction execution subsystem using the communication interface via an external network with an electronic services provider.

According to yet another aspect, a method is provided for initiating an electronic services transaction. The method includes: providing a computer peripheral device having a communication link with an electronic service site and an interface system for initiating an electronic service transaction between the computer peripheral device and the electronic services site; detecting a need to initiate an electronic service transaction from the computer peripheral device with an external electronic services site; and initiating an electronic service transaction in response to the detected need using the computer peripheral device.

An advantage is to provide an apparatus and method for initiating any form of e-service transaction at a computer peripheral device connected to the Internet. In some cases, the apparatus and method are capable of carrying out the entire e-service transaction.

### DESCRIPTION OF THE DRAWINGS

Preferred embodiments of the invention are described below with reference to the following accompanying drawings depicting examples embodying the best mode for practicing the invention.

FIG. 1 is a simplified block diagram of a network environment including a computer peripheral device having the ability to render and consummate an electronic service transaction over the network, in accordance with one embodiment of the present invention.

FIG. 2 is a logic flow diagram illustrating logical steps used to implement a method of initiating and consummating an electronic service transaction from a computer peripheral device over the Internet using the device of FIG. 1.

### DETAILED DESCRIPTION OF THE INVENTION

This disclosure of the invention is submitted in furtherance of the constitutional purposes of the U.S. Patent Laws “to promote the progress of science and useful arts”. U.S. Constitution, Article 1, Section 8.

Reference will now be made to a preferred embodiment of Applicant's invention. An exemplary implementation is described below and depicted with reference to the drawings comprising an apparatus for initiating and completing an electronic service transaction from a computer peripheral device. While the invention is described by way of a preferred embodiment, it is understood that the description is not intended to limit the invention to this embodiment, but is intended to cover alternatives, equivalents, and modifications such as are included within the scope of the appended claims.

In an effort to prevent obscuring the invention at hand, only details germane to implementing the invention will be described in great detail, with presently understood peripheral details being incorporated by reference, as needed, as being presently understood in the art.

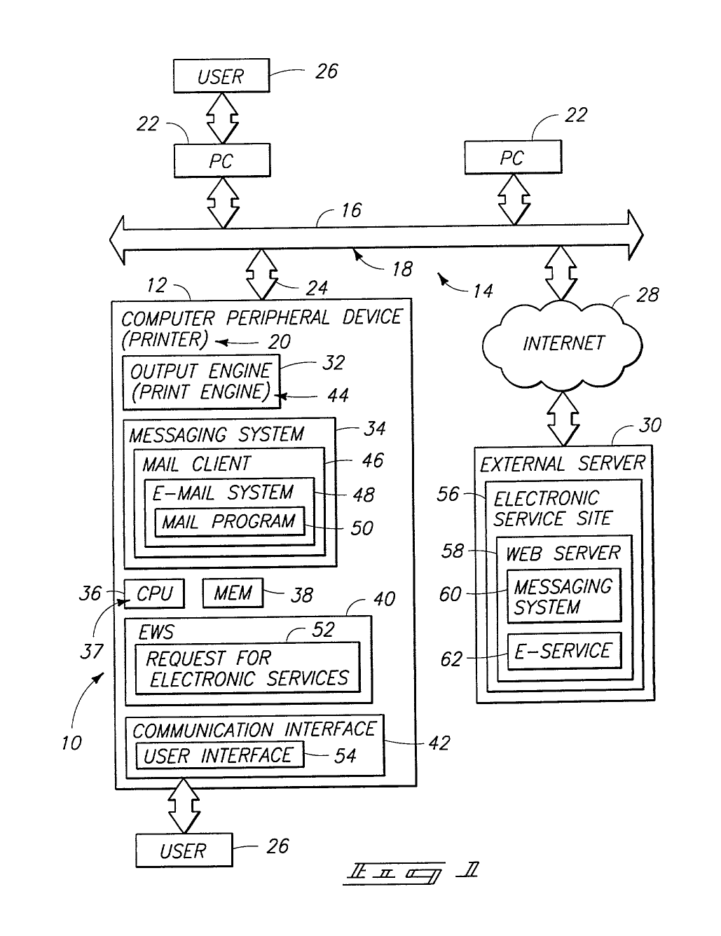

FIG. 1 is a simplified block diagram of an apparatus for initiating and consummating an electronic service transaction over a network, identified by reference numeral 10. Apparatus 10 is initiated from a computer peripheral device 12 within a network environment 14 over a network 16, such as over a communication link 18. In one embodiment, computer peripheral device 12 comprises a printer 20. Printer 20 is connected with a personal computer (PC) 22 via a local bus 24.

As shown in FIG. 1, a plurality of personal computers (PCs) 22 are coupled together via network 16 with a computer peripheral device 12 via local bus 24. According to one embodiment, computer peripheral device 12 comprises a printer 20, such as a laser printer. Printer 20 includes a communication link 18, in one form a connection over an external network such as the Internet 28. Internet 28 connects together an external server 30 comprising an electronic service site 56. Electronic service site 56 includes a web server 58 having a messaging system 60.

More particularly, an electronic service provider is resident at electronic service site 56. Additionally, messaging system 34 provides “store and forward” capabilities with electronic service site 56 via messaging system 60, according to one embodiment. “Store and forward” capabilities refers to the temporary storage of a message for transmission to a destination at a later time. Accordingly, “store and forward” capabilities allow for routing of messages/data over networks that are not continuously accessible.

More particularly, printer 20 comprises output engine 32, messaging system 34, CPU 36, memory 38, an embedded web server (EWS) 40, and a communication interface 42. EWS 40 provides one embodiment of a transaction execution subsystem. Another embodiment is provided by a Java Virtual Machine (JVM). In one form, output engine 32 comprises a print engine 44 including the unit within a printer that actually performs printing. For example, in a laser printer, print engine 32 comprises a laser and mechanism to transfer toner onto paper media.

According to one embodiment, messaging system 34 comprises a mail client 46 including an e-mail system 48 having send and receive capabilities for messages and information. Optionally, messaging system 34 comprises communications across a socket, a hypertext transfer protocol (HTTP), or any type of messaging protocol coupled with a transmission vehicle, physical connection, or communication link. According to one construction, e-mail system 48 comprises a mail program, or e-mail application program, 50 such as an e-mail program that resides in a processing device, such as printer 20, and has access to mail servers on network 16. One such mail server is provided by web server 58 of external server 30.

EWS 40 comprises a request for electronic services 52 that is launched by EWS 40 when a user 26 interacts via a user interface 54 of communication interface 42.

As used herein, the term “e-service transaction” refers to an electronic service transaction such as a transaction that is implemented over a network using an electronic messaging system. Additionally, the term “document” is intended to include part or all of a web page that is accessible at a client or a computer peripheral device.

Apparatus 10 enables the initiation of e-service transactions at a computer peripheral device 12 such as a printer 20. Apparatus 10, in some cases, can also complete an e-service transaction. According to one technique, a computer peripheral device can initiate an electronic service transaction through self-access, such as via a self-initiated wake-up, a timed event, a polled event, or a trigger state. According to another technique, a computer peripheral device can initiate an electronic service transaction via user initiation using the computer peripheral device.

More particularly, e-service is intended to refer to any type of electronic service deliverable over a network 16. An e-service transaction can provide an e-service either for free, or for a fee. Even for the case where computer peripheral device 12 comprises a printer 20, e-services may not necessarily be print-related. The initiation and completion of a nearly unlimited list of e-services are envisioned according to this invention.

For example, print-related e-services can include, but are not limited to, scheduling of printer maintenance, upgrading of device firmware, ordering of consumables for a device, downloading and/or printing of manuals or other documents, and upgrading of a device driver. Examples of non print-related e-services include, but are not limited to, sending an e-mail to a system administrator, receiving a latest stock quote for a desired stock, and receiving a latest weather report.

With respect to printer 20, printer 20 is connected via network 16 with the Internet 28. Optionally, printer 20 can be directly connected with Internet 28 via a cable Internet connection, or via an ISDN line. Hence, apparatus 10 requires that printer 20 be able to access the Internet 28 in order to connect to and initiate a transaction with an e-service 62 that is available from external server 30. Optionally, printer 20 is capable of causing another process or device to access e-service 62 via Internet 28. It is understood that such access can be provided via a dial-up access method, a dedicated Internet connection, or any other method of initiating an electronic service connection.

Printer 20 is capable of initiating an e-service transaction. Additionally, printer 20 may be able to carry out the transaction. More particularly, printer 20 is provided with processing circuitry 37 that is able to determine what e-service transaction or transactions to initiate and when best to initiate such transaction(s).

According to one implementation, input is provided at printer 20 by user 26 in order to determine what e-service to initiate. More particularly, user 26 navigates through one or more menus on user interface 54 within a control panel of printer 20 to select or input a particular e-service. Otherwise, user 26 causes printer 20 to initiate a particular e-service.

According to another implementation, initiation of an e-service is triggered by a print-time state. More particularly, at the time a print event occurs, the print driver initiates an e-service transaction based on the state of the printer and/or the contents of the current print job.

According to yet another implementation, initiation of an e-service is triggered by statistical analysis. More particularly, a print driver tracks behavior of user 26 over a period of time in order to determine the needs of user 26. Alternatively or additionally, the print driver tracks a user's behavior over a set of print jobs in order to determine the user's needs. For example, the average amount of toner being used by a particular user can be tracked.

In each case, an e-service transaction could be initiated by launching a printer-based web browser, then pointing (or navigating) the browser to an e-service site where user 26 can complete the e-service transaction. Alternatively, a printer-based web browser can connect to an e-service site and carry out an entire transaction automatically with no user interaction. Further alternatively, a printer-based web browser can implement a combination of the above two techniques; namely, combining launching and pointing of the browser along with connecting to an e-service site and automatically carrying out an entire transaction.

According to a first example, an e-service is provided to render web pages, then return the rendered web pages as PCL5 or PostScript print streams. Details of one such implementation for returning rendered web pages as PCL 5 or PostScript print streams is disclosed in U.S. patent application Ser. No. 09/439,315, filed on Nov. 12, 1999, and entitled “System and Method for Monitoring a Computer System Process or Peripheral”. Such U.S. patent application No. 09/439,315 is herein incorporated by reference.

According to the first example, a user's printer is connected to the Internet, and the user points the printer to a specific document or web page on the Internet. The term “pointing” refers to navigating to the document or web page. The user then requests that the document be printed. In response, the printer sends the uniform resource locator (URL) for the document or web page to the e-service provider at the electronic service site. The printer also requests that the document or web page be sent back to the printer as a print stream. Upon receiving the print stream, the printer prints the document or web page.

According to a second example, an e-service is provided to sell toner for a laser printer. According to prior art techniques, a user would be required to learn (from others) that a particular web site exists. More particularly, the user would learn from print advertisements or television advertisements, then manually point their web browser to the web site in order to conduct a transaction. However, the present technique obviates the need for a user to learn in this manner.

According to the second example, a user's printer is configured to access the Internet. The user's printer is instrumented to monitor toner level in a toner cartridge of the printer. One exemplary technique for monitoring toner level is disclosed in U.S. Pat. No. 5,862,431, herein incorporated by reference. A user configures the printer to automatically order toner from the e-service when toner level is detected as falling to a predetermined, detected level. When the predetermined (or preset) level is reached, the printer automatically connects to the electronic service (e-service) site via the Internet and orders a new toner cartridge.

By implementing the above-described invention, e-services are made more accessible to users without requiring the use of a personal computer (PC), or other host computer. Additionally, e-services transactions can be initiated at the place and time where they are needed; in one case, at a printer that has run out of toner. For the case of a printer, the printer can be pre-configured to know where certain e-services exist on the Internet.

Accordingly, print-related transactions can be initiated by a printer. The printer has access to most or all of the information that is necessary to trigger an e-services transaction. The printer can also have access to information necessary to carry out an e-service transaction. Examples of such print-related transactions include transfer of a printer model number and configuration, transfer of the state of a printer, and transfer of the contents of current or past print jobs.

Using these techniques, a printer can also track a user's behavior in order to determine which transactions to initiate, and when to initiate them. Furthermore, e-services can be made available to a user through a printer that the user has already installed to a local computer that might not have Internet access. Even further, certain e-services which the user might use can be pre-set to settings provided by a manufacturer of the printer. Hence, the manufacturer can provided settings that route the e-service back to the manufacturer, thereby allowing the manufacturer to realize a financial advantage from any resulting e-service transaction.

Accordingly, any form of e-services transaction can be initiated at a computer peripheral device, such as a printer that is connected to the Internet and has a capability to initiate and possibly carry out an e-service transaction.

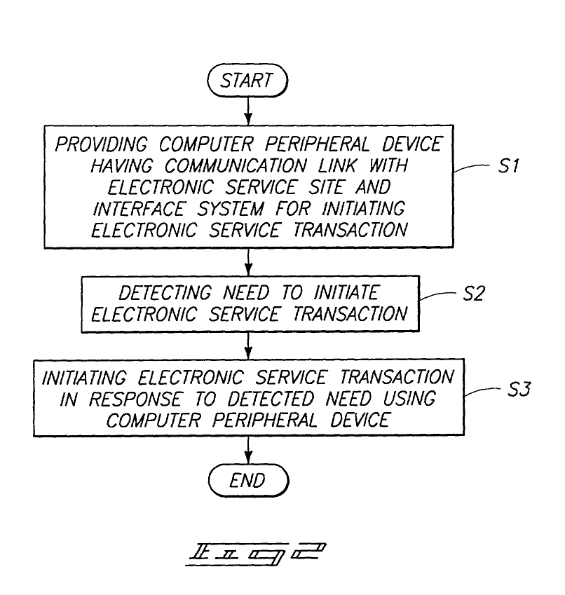

FIG. 2 forms a process flow diagram showing the logic processing within a computer peripheral device for initiating an electronic service transaction.

In Step “S1”, a user such as a printer user is provided with direct access to a computer peripheral device having a communication link with an electronic service site. The computer peripheral device also has an interface system such as a user interface for initiating an electronic service transaction between the computer peripheral device and the electronic service site. After performing Step “S1”, the process proceeds to Step “S2”.

In Step “S2”, a need is detected to initiate an electronic service transaction from the computer peripheral device with an external electronic service site. One way is for the computer peripheral device to detect a need for the transaction. Another way is for a user to detect the need for the transaction. After performing Step “S2”, the process proceeds to Step “S3”.

In Step “S3”, an electronic service transaction is initiated in response to the detected need using the computer peripheral device. After performing Step “S3”, an electronic service transaction can be completed.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An electronic service transaction apparatus, comprising:
a computer peripheral device having a communication link and a messaging system operative to provide send and receive capabilities with an electronic service site;
wherein the communication link is operative to connect the computer peripheral device with the electronic service site through the Internet, and the messaging system is accessed directly by the computer peripheral device to initiate an electronic service transaction from the computer peripheral device with the electronic service site.

2. The apparatus of claim 1 wherein the computer peripheral device comprises an embedded web server, and wherein the embedded web server is operative to forward a request for an electronic service to the electronic service site from the computer peripheral device via the messaging system.

3. The apparatus of claim 1 wherein the computer peripheral device comprises a messaging system that enables initiation of an electronic service transaction from an electronic service site.

4. The apparatus of claim 1 wherein the communication link comprises an electronic communication link provided by a mail client of the computer peripheral device that enables a user to submit an e-mail order using a mail program from the computer peripheral device to an external provider of electronic services.

5. The apparatus of claim 1 wherein the messaging system comprises an e-mail system including a mail program operative to provide send and receive capabilities between the computer peripheral device and an external electronic service site.

6. The apparatus of claim 1 wherein the messaging system comprises a dedicated Internet connection.

7. The apparatus of claim 1 wherein the computer peripheral device connects with an external server via the Internet, the computer peripheral device accesses a document on the external server to render a web page, and the electronic service transaction comprises sending a URL for the document to the electronic service, and receiving a print stream from the external server for the document.

8. The apparatus of claim 1 wherein the computer peripheral device automatically generates a consumable order message in response to the computer peripheral device detecting a need to replenish a consumable and further forwards a notification to a consumable order web site on an external web server indicating a need to replenish the consumable.

9. The apparatus of claim 1 wherein the computer peripheral device comprises a printer connected with the Internet via the communication link, wherein a user accesses a document on the Internet via the printer and prints the document using the printer.

10. A computer peripheral device, comprising:
an output engine;
a transaction execution subsystem communicating with the output engine;
a communication interface communicating with the transaction execution subsystem; and
processing circuitry communicating with the transaction execution subsystem and operative to initiate an electronic services transaction from the transaction execution subsystem using the communication interface via an external network with an electronic services provider.

11. The computer peripheral device of claim 10 wherein the output engine comprises a print engine communicating with the transaction execution subsystem.

12. The computer peripheral device of claim 10 wherein the communication interface comprises a user interface of a computer peripheral device.

13. The computer peripheral device of claim 10 wherein the transaction execution subsystem comprises an embedded web server.

14. The computer peripheral device of claim 13 wherein the CPU is further operative to carry out an e-services transaction using the transaction execution subsystem of the computer peripheral device.

15. A method of initiating an electronic services transaction, comprising:
providing a computer peripheral device having a communication link with an electronic service site and an interface system for initiating an electronic service transaction between the computer peripheral device and the electronic service site;
detecting a need to initiate an electronic service transaction from the computer peripheral device with an external electronic service site; and
initiating an electronic service transaction in response to the detected need using the computer peripheral device.

16. The method of claim 15 wherein the computer peripheral device comprises an embedded web server, the electronic service site comprises a site web server and the communication link comprises an Internet messaging system extending between the computer peripheral device and the site server.

17. The method of claim 15 wherein detecting a need for an electronic services transaction comprises receiving a user input at a user interface of a computer peripheral device that initiates an e-services transaction.

18. The method of claim 15 wherein the computer peripheral device comprises a printer.

19. The method of claim 18 wherein detecting a need for an electronic services transaction comprises detecting a need to order toner.

20. The method of claim 18 wherein the printer completes an electronic services transaction with the electronic service site.
